(19) United States
(12) Patent Application Publication
(10) Pub. No.: US 2003/0102612 A1
(43) Pub. Date: Jun. 5, 2003

(54) External guide from fiber-reinforced plastic for use in a pneumatic spring system

(76) Inventors: Antonio Branco, Hamburg (DE); Michael Weber, Buchholz (DE)

Correspondence Address: WILLIAM COLLARD, COLLARD & ROE, P.C., 1077 NORTHERN BOULEVARD, ROSLYN, NY, 11576, US

(21) Appl. No.: 10/019,610

(22) PCT Filed: Apr. 20, 2001
(86) PCT No.: PCT/DE01/01526

(30) Foreign Application Priority Data
May 2, 2000 (DE) 100 21 020.1

(51) Int. Cl. F16F 9/38

(52) U.S. Cl. 267/64.24; 267/64.27; 188/322.12

(57) ABSTRACT

The invention relates to a pneumatic spring system, comprising at least the following components, namely air-spring bellows, an air-spring cover, an air-spring piston and an external guide. The inventive pneumatic spring system is characterized in that the external guide consists of a plastic material with a solid support embedded therein.

### DESCRIPTION

The invention relates to a pneumatic spring system as defined in the introductory part of patent claim 1. Pneumatic spring systems of said type are primarily employed in motor vehicle technology.

A pneumatic spring system of this type comprised of a pneumatic spring cover, a pneumatic spring piston and a pneumatic spring bellows with an additional external guide is described, for example in the published patent documents DE-A-36 43 073 and DE-A-100 01 018. If need be, the pneumatic spring system may be provided with a vibration damper (shock absorber) and/or a protective sleeve as well, whereby reference is made in this regard to published patent document DE-A 197 53 637.

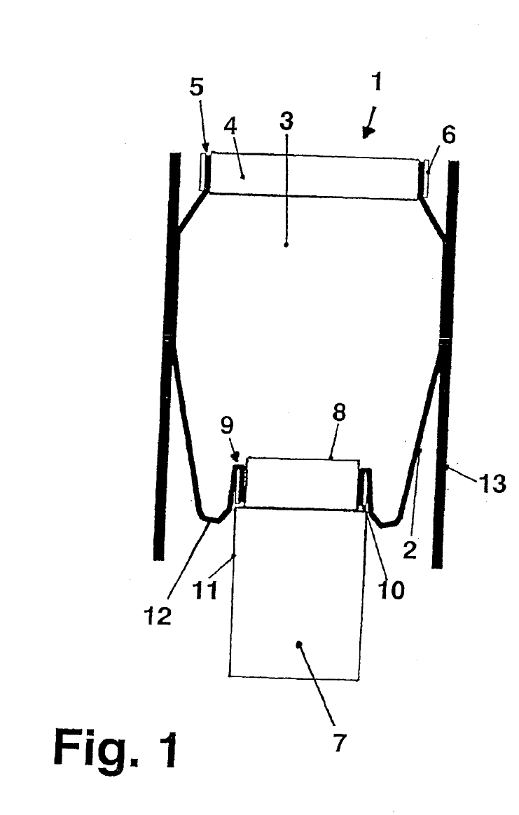

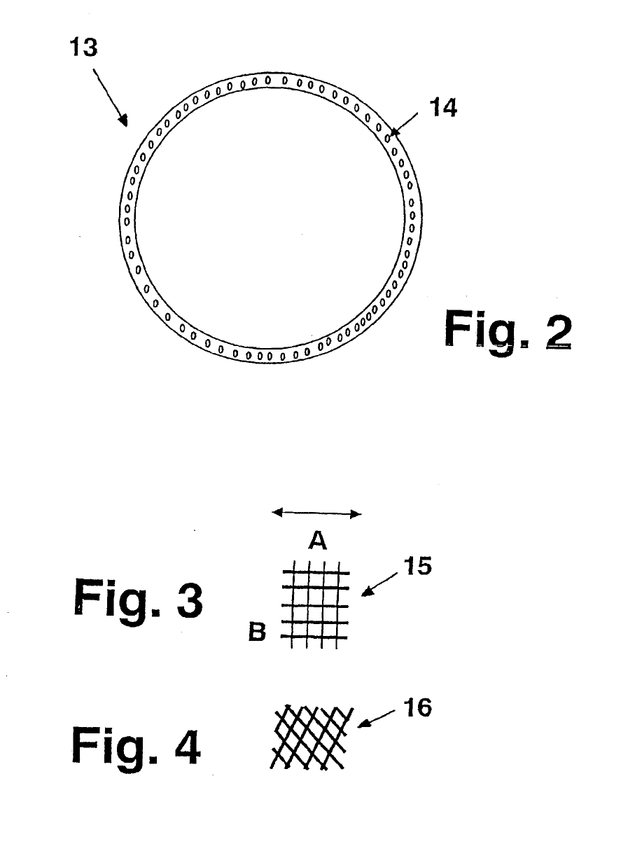

The pneumatic spring bellows is provided with an embedded reinforcement in most cases, notably in the form of an axial bellows (DE-A-36 43 073; FIG. 1) or in the form of a bellows with a crossed layer structure (DE-A-29 04 522; FIG. 2). With an axial bellows with its axially extending fiber reinforcements, it is necessary to equip the pneumatic spring bellows with an external guide. The external guide has been made until now of a metallic material, in particular of an aluminum alloy.

Now, the problem of the invention is to provide at favorable cost an alternative to the external guides known heretofore, notably with reduction of the weight at the same time.

Said problem is solved according to the characterizing part of claim 1 in that the external guide is made of plastic comprising an embedded reinforcement.

Useful further developments of the invention are specified in claims 2 to 8.

The invention is described in the following in greater detail with the help of exemplified embodiments and by reference to schematic drawings, in which:

FIG. 1 shows a pneumatic spring system with an external guide.

FIG. 2 shows the cross section through an external guide.

FIG. 3 shows a fabric comprising a warp-and-weft structure; and

FIG. 4 shows a fabric with a crossed structure.

FIG. 1 shows a pneumatic spring system 1, whereby the pneumatic spring bellows 2 made of elastomeric material encloses an air chamber 3 with an elastic volume. The pneumatic spring bellows is provided in this connection with an embedded reinforcement in most cases, in particular in the form of an axial bellows.

The pneumatic spring cover 4, which usually has the shape of a pot, and which, furthermore, frequently serves as the pressure container, comprises a first fastening area 5 on which the one end of the pneumatic spring bellows 2 is secured by means of a clamping ring 6.

The pneumatic spring piston 7, as a tubular structural component, comprises a face area 8 that is arranged opposing the pneumatic spring cover 4. Said face area is laterally adjoined by the second fastening area 9 on which the other end of the pneumatic spring bellows 2 is secured. Said end of the bellows is fastened there by clamping by means of a clamping ring 10 as well, whereby the end of the bellows is beaded around the clamping ring. Said fastening area is provided with an undercut in most cases, forming a shoulder. Furthermore, as the pneumatic spring bellows 2 is compressed, a loop 12 is produced which is capable of rolling off on the roll-off surface 11 of the pneumatic spring piston.

The external guide 13, which is secured on the pneumatic spring cover and/or a structural component fixed on the body of the vehicle, and/or the pneumatic spring bellows (reference is made in this regard, for example to published patent document DE-U-298 23 508) substantially encloses the entire range of the pneumatic spring bellows 2.

Now, FIG. 2 shows the tubular external guide 13 made of a plastic with high impact strength, which is preferably based on a polyamide or polyester. The plastic is provided with an embedded reinforcement 14. Said reinforcement consists of fibers, in particular glass fibers, which can be mixed into the plastic. A fabric construction is possible as well especially provided with a reinforcement in the form of one layer, whereby two variations are introduced in the following.

According to FIG. 3, the fabric 5 is present in the form of a warp-and-weft structure, whereby the warp direction “A” is the axial direction and the weft direction “B” is the peripheral direction (direction of arrow) of the external guide 13.

According to FIG. 4, the fabric 16 has a crossed structure.

Preferably glass fibers are used as base material for the fabrics 15 and 16.

The external guide made of plastic with the reinforcements incorporated therein leads to a reduction of the wall thickness and thus to a reduction of the weight.

### List of Reference Numerals

1 Pneumatic spring system

2 Pneumatic spring bellows

3 Air chamber

4 Pneumatic spring cover (pneumatic spring pot; pressure container)

5 First fastening area

6 Clamping ring

7 Pneumatic spring piston (roll-off piston, immersing piston)

8 Face area

9 Second fastening area

10 Clamping ring

11 Roll-off surface

12 Loop (rolling fold)

13 External guide

14 Reinforcement

15 Fabric with warp-weft structure with warp direction A and weft direction B

16 Fabric with crossed structure

1. A pneumatic spring system (1) at least comprising the following components:
A pneumatic spring bellows (2) made of elastomeric material enclosing an air chamber (3) with an elastic volume, whereby the pneumatic spring bellows is provided with a reinforcement in most cases, in particular in the form of axially extending fiber reinforcements.
A pneumatic spring cover (4) with a first fastening area on which the one end of the pneumatic spring bellows (2) is secured by means of a clamping ring (6) or the like.
A pneumatic spring piston (7) comprising
a face area (8) arranged opposite the pneumatic spring cover (4);
a second fastening area (9) on which the other end of the pneumatic spring bellows (2) is secured by means of a clamping ring (10) or the like as well; and
a lateral roll-off surface (11) on which the pneumatic spring bellows (2) is capable of rolling off, forming a loop (12);
as well an external guide (13) for the spring bellows (2);
characterized in that
the external guide (13) consists of plastic with an embedded reinforcement (14).

2. The pneumatic spring system according to claim 1, characterized in that the plastic is a polymer with high impact strength preferably based on a polyamide or polyester.

3. The pneumatic spring system according to claim 1 or 2, characterized in that the reinforcement (14) consists of fibers.

4. The pneumatic spring system according to claim 3, characterized in that the reinforcement (14) consists of glass fibers.

5. The pneumatic spring system according to any one of claims 1 to 4, characterized in that the reinforcement (14) is present in the form of a fabric (15, 16).

6. The pneumatic spring system according to claim 5, characterized in that the fabric is present in the form of a warp-weft structure, whereby the warp direction (A) is the axial direction and the weft direction (B) is the peripheral direction of the external guide (13).

7. The pneumatic spring system according to claim 5, characterized in that the fabric is present in the form of a crossed structure.

8. The pneumatic spring system according to claims 5 to 7, characterized in that the fabric (15, 16) is arranged in one layer.
